(19) United States
(12) Patent Application Publication
(10) Pub. No.: US 2010/0272499 A1
(43) Pub. Date: Oct. 28, 2010

(54) ENVIRONMENTALLY FRIENDLY DISPOSABLE PEN

(76) Inventors: Erik Wysocan, New York, NY (US); Leon Ransmeier, New York, NY (US)

Correspondence Address: FOX ROTHSCHILD LLP;New York, 997 Lenox Drive, Bldg. #3, Lawrenceville, NJ, 08648, US

(21) Appl. No.: 12/428,837

(22) Filed: Apr. 23, 2009

(51) Int. Cl. B43K 5/00

(52) U.S. Cl. 401/221

(57) ABSTRACT

An ecological friendly disposable pen includes a main housing, a plug, a cap, an ink reservoir set within the main housing, and a nib sub-assembly. The nib sub-assembly may include a nib, which provides the writing end of the pen, and a wick, which carries ink from the reservoir to the nib. The plug plugs one end of the main housing, and the nib sub-assembly is set within the other end of the main housing. The ink reservoir stores a non-toxic ink. The plug, cap, ink reservoir and main housing are all formed from biodegradable, non-toxic materials.

### FIELD OF THE INVENTION

The present invention relates generally to disposable pens. More particularly, the present invention discloses an environmentally friendly biodegradable pen.

### BACKGROUND OF THE INVENTION

Disposable pens are a staple of modern living. According to the Writing Instrument Manufactures Association, in 2007 more than 5 billion ball point pens were shipped. The vast majority of these are disposable pens that are made from standard plastics and inks. Such pens are not biodegradable and can be a significant source of toxins in landfills; the inks in particular may be quite toxic and thus be a source of groundwater contamination in or near landfills.

Accordingly, there is an immediate need for ecologically friendly disposable pens that are both biodegradable and non-toxic.

### SUMMARY OF THE INVENTION

The present invention overcomes the drawbacks of the prior art. The present invention discloses an ecologically friendly writing instrument that is biodegradable and non-toxic.

Preferred embodiment writing instruments include a biodegradable main housing, a biodegradable ink reservoir disposed within the main housing, non-toxic ink disposed within the ink reservoir, and a nib coupled to the main housing and fluidly connected to the ink reservoir. In various embodiments the main housing comprises at least one of a biodegradation-enhancing additive or a biodegradable polymer. Other embodiments further include a biodegradable plug for plugging an end of the main housing. The main housing may also include an indentation to facilitate removal of the nib from the main housing.

In certain embodiments a wick is further provided that is fluidly connected to the nib and the ink reservoir. A nib adapter may also mechanically couple to the wick and to the nib, and be configured to mechanically engage with the main housing. In such embodiments the nib adapter is preferably biodegradable. In certain embodiments the nib is integrally formed with the wick, and the nib may be a felt tip nib. In other embodiments the nib is a rollerball nib. In preferred embodiments the wick is biodegradable. In particularly preferred embodiments the ink is biodegradable. In specific embodiments, the ink reservoir comprises an ink-holding material and a sheath surrounding at least a portion of the ink-holding material.

Various embodiments provide an environmentally friendly disposable writing instrument. More particularly, specific embodiments provide a disposable pen that is both biodegradable and non-toxic when disposed in landfills.

### BRIEF DESCRIPTION OF THE DRAWINGS

FIG. 1 is a side view of an embodiment pen.

FIG. 2 is a cross-sectional view along line A-A of the embodiment pen shown in FIG. 1.

FIG. 3 is an exploded perspective view of the embodiment pen shown in FIG. 1.

FIG. 4 is an exploded perspective view of another embodiment pen.

FIG. 5 is a cross-sectional view of an embodiment ink reservoir.

FIG. 6A is a side view of another embodiment main housing.

FIG. 6B is a detailed view of a nib sub-assembly disposed within an opening of the main housing depicted in FIG. 6A.

### DETAILED DESCRIPTION

For purposes of the following, the term “non-toxic” means materials that are approved by a toxicologist to contain a minimal percentage of potentially toxic chemicals so as to avoid any human health risks or environmental contamination. Non-toxic inks preferably meet one or more of the ink toxicity standards promulgated by The Art & Creative Materials Institute, Inc., conforming to ASTM D4236; the European Union Dangerous Substances Directive 67/548/EEC and Directive 98/8/EC (regarding environmental toxicity); and the U.S. Labeling of Hazardous Art Materials Act (Public Law 100-695).

The term “compostable” indicates a material that is tested and approved to biologically degrade into safe, usable compost in a predetermined period of time, which is preferably 180 days. Compostable plastic materials preferably conform to the ASTM D6400 standard.

The term “renewable” indicates a product containing at least 95% non-petroleum resources.

The term “biodegradable” as applied to polymers, such as plastics or bioplastics, indicates a material that can biodegrade either aerobically or anaerobically through the action of microorganisms. Aerobic biodegradable materials include plastics that are “compostable” as defined above or biodegrade in the natural environment, preferably as certified by the “OK Biodegradable Soil” standard as set forth by Vincotte (available at http://www.aib-vincotte.hu/new/documents/pdf/vincotte_referenciak/okb-en.pdf). Anaerobic biodegradable materials include plastics that degrade in oxygen-free environments and preferably show degradation in tests that conform to ASTM 5511.

The term “biodegradable” as applied to ink indicates an ink (and the biocides, if any, therein) that is proven to degrade to independently determined acceptable levels of safety, such as one or more of the standards as set forth in European Union Directive 67/548/EEC Annex VI, Section 5.2.1.3 and Directive 98/8/EC. A “biodegradable ink” therefore preferably degrades more than 60% in a duration of less than or equal to 28 days, under standard EU and OECD test conditions.

The term “environmentally friendly” means materials that are made from renewable or recycled materials, are biodegradable and are non-toxic.

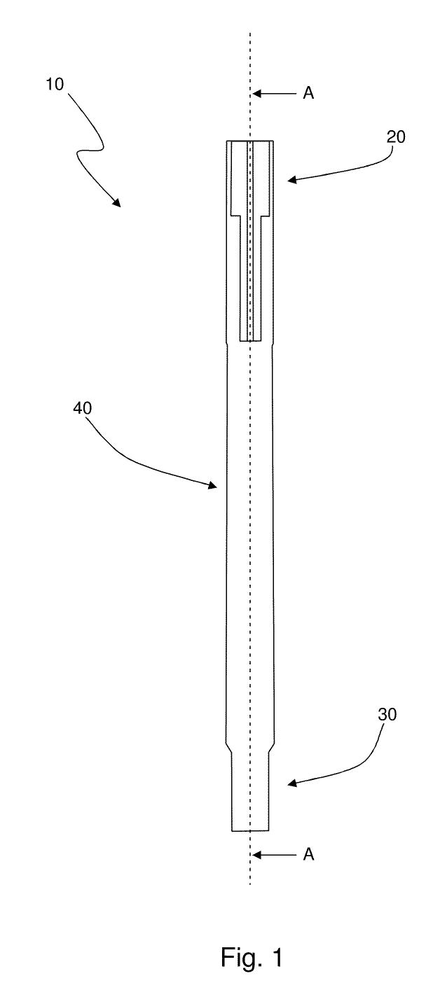

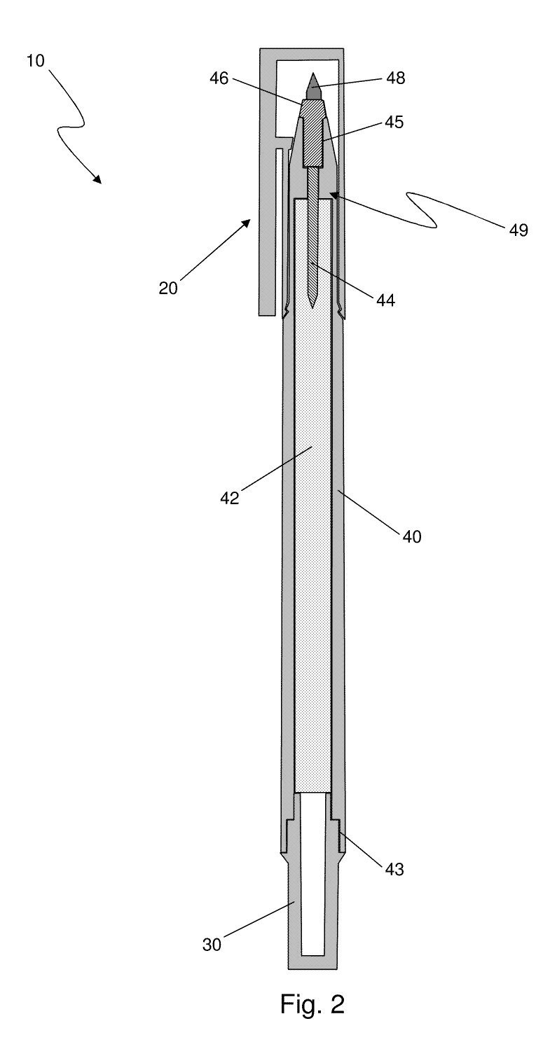

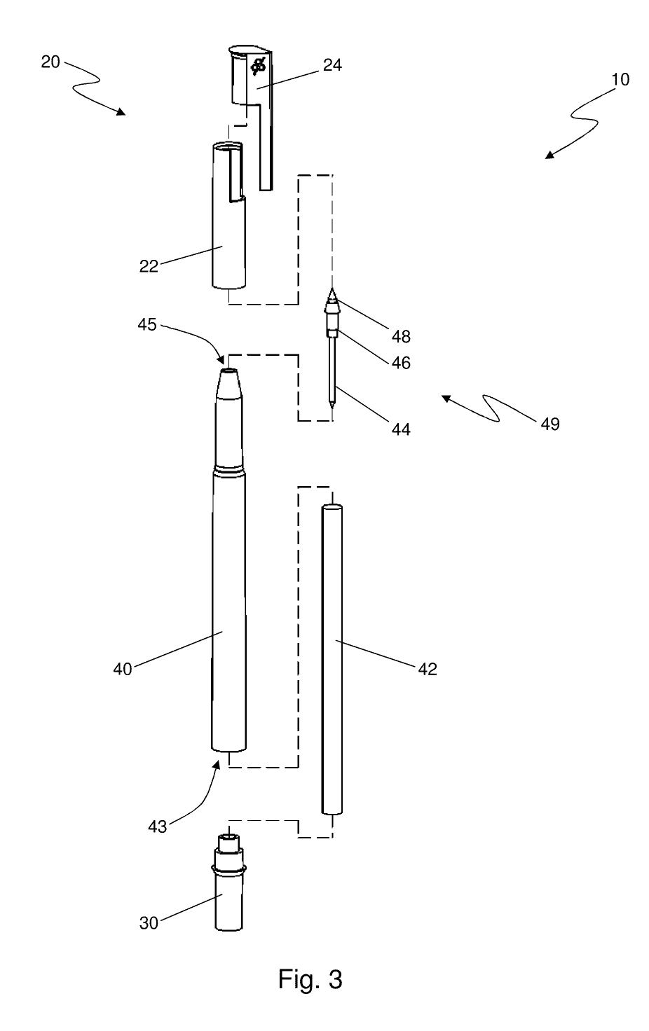

An embodiment writing instrument 10 is shown in FIGS. 1-3. FIG. 1 shows a side view of the writing instrument 10. FIG. 2 is a cross-sectional view of the writing instrument 10 along line A-A indicated in FIG. 1. FIG. 3 is an exploded perspective view of the writing instrument 10. The writing instrument 10 is a ballpoint pen 10 that includes a cap 20, a plug 30 and a main housing 40. The cap 20 is removably attached to the main housing 40 and is used to cover and protect the marking or writing end of the pen 10. The cap 20 may include a clip 24 connected to a cap base 22 in any standard manner, such as by a snap-fit connection, gluing, welding or any other suitable means. The base 22 provides a snap or friction fitting to the main housing 40 in a standard manner. The clip 24 is provided as a convenience to a user, as known in the art. Of course, the cap 20 may also be provided or formed as a monolithic device.

The plug 30 is used to seal an opening 43 in the end of main housing 40 that is opposite to the writing end of the pen 10 and thus prevent the drying out of ink contained within the main housing 40. A snap or friction fitting may be used to secure the plug 30 within opening 43 of the main housing 40, as known in the art.

The main housing 40 is hollow to accept an ink reservoir 42 and a nib sub-assembly 49. In specific embodiments the ink reservoir 42 is made from an absorbent material to hold ink. In some embodiments the ink reservoir 42 is made from wool. Such wool reservoirs are available on the market. In other embodiments the reservoir 42 is made from a spun polymer, such as polyester, polypropylene or the like, with a biodegradation-enhancing additive, such as EcoPure from Bio-Tec Environmental, LLC of Albuquerque, N.M. By way of a prophetic example, EcoPure may be added to a reservoir as developed by Filtrona, of Milton Keynes, England. The main housing 40 may be formed using injection molding processes, and is preferably made from any suitable biodegradable material. Further, the main housing 40 is preferably non-toxic and, when it degrades, does not degrade into toxic materials. In particularly preferred embodiments the main housing 40 is compostable, and even more preferably environmentally friendly. Preferred materials for the main housing 40 include polypropylene with a biodegradation-enhancing additive, such as EcoPure, or BioBatch from Bio-Tec Environmental LLC of Albuquerque, N.M. Alternatively, starch-based polymers may be used, such as Mater-Bi from Novamont SPA, of Novara, Italy. Other suitable materials may include BioPlast from Biotec GmbH & Co. of Emmerich, Germany; and Mirel from Metabolix, Inc. of Lowell, Mass. In preferred embodiments the cap 20 and the plug 30 are all also made from the same materials as the main housing 40, and may be formed, for example, by way of injection molding processes; however, any suitable biodegradable materials may be used for the cap 20 and plug 30.

The nib sub-assembly 49 includes a wick 44, a nib adapter 46 and a nib 48. The wick 44 is disposed within the reservoir 42 and carries ink to the nib 48 via, for example, capillary action. The nib adapter 46 mechanically and fluidly connects the nib 48 to the wick 44, and further mechanically connects the nib sub-assembly 49 to the main housing 40. For example, the nib adapter 46 may have an external shape that conforms to the shape of an opening 45 in the writing end of the main housing 40 to provide a friction fitting between the nib adapter 46 and the main housing 40. In some embodiments the wick 44 is not required, and instead the nib 48 extends to connect directly with the reservoir 42.

In certain embodiments the wick 44 is made from polyester. In other embodiments, the wick 44 is made from a combination of polyester and EcoPure. Yet other alternative embodiments include making the wick 44 from wool, or from a combination of a porous plastic and EcoPure. In preferred embodiments the nib adapter 46 is made from the same material as the main housing 40; however, any suitable material, both biodegradable and non-biodegradable (but preferably non-toxic) may be used for the nib adapter 46. The nib 48 may be a standard rollerball nib and in specific embodiments is made from stainless steel, although any other suitable material may be used.

The ink contained within reservoir 42 is preferably non-toxic. Simply by way of example, non-toxic inks include inks as found in the Pentel Hyper G Gel Pen (Torrance, Calif.), which meet the standards set forth by both the Art & Creative Materials Institute, conforming to ASTM D4236, and the U.S. Labeling of Hazardous Art Materials Act (Public Law 100-695). Other non-toxic inks include inks as found in Schneider Pen, (Schramberg, Germany), which meet the standards set forth in the European Union Dangerous Substances Directive 67/548/EEC, conforming to ASTM D4236, as well as Directive 98/8/EC. In particularly preferred embodiments, the ink contained with the reservoir 42 is both non-toxic and biodegradable.

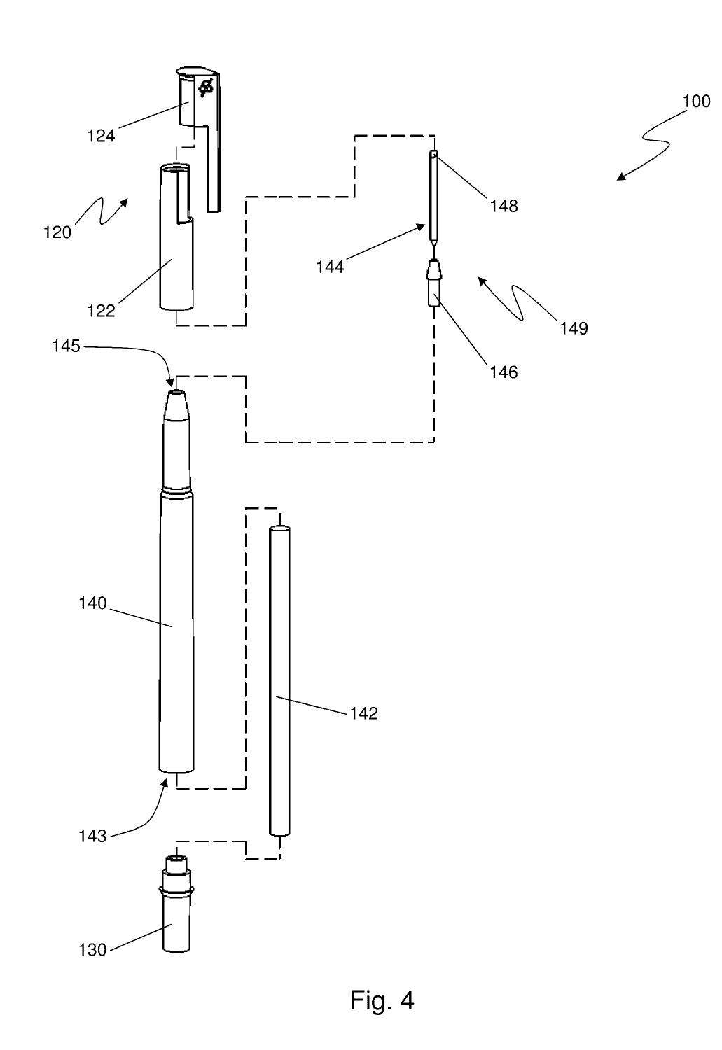

An exploded perspective view of another embodiment writing instrument 100 is shown in FIG. 4. The writing instrument 100 is a felt tip pen 100. The pen 100 includes a hollow main housing 140, a plug 130, an ink reservoir 142, a cap 120 and a nib sub-assembly 149. The plug 130 is used to plug opening 143 of the main housing 140 to prevent drying of ink within the main housing 140. Cap 120 is used to removably cover the writing end 148 of the pen 100, and may be formed as a single piece or, as shown in FIG. 4, may be formed from a clip 124 that is connected to a cap base 122. The main housing 140 holds the ink reservoir 142, which in turn stores ink for the pen 100. The nib sub-assembly 149 is disposed through, and engages with, opening 145 in the main housing 140. The nib sub-assembly 149 includes a nib adapter 146 that mechanically engages with the opening 145 and which holds a nib 148. The nib 148 provides a felt tip writing end for the pen 100, and is integrally formed with a wick 146 that extends from the nib 148 to fluidly connect with the ink reservoir 142.

The components 120, 130, 140 and 146 may be made from the same materials, using the same processes, as are used for the corresponding components 20, 30, 40 and 46 in the first embodiment pen 10. Similarly, the reservoir 142 may be made from the same materials that are used for the reservoir 42 in the first embodiment 10. The felt tip nib 148 may be integrally formed with the wick 144 and is preferably made from wool. In other embodiments, the nib/wick 148/144 is made from a combination of a porous plastic with EcoPure. The ink is preferably non-toxic, biodegradable or both.

All, or nearly all, of the components that make up the embodiment writing instruments 10, 100 are biodegradable. Hence, if the preferred aerobic-biodegradable plastic is used it is expected that the embodiment writing instruments 10, 100 will substantially decompose in a composting facility within about, for example, 180 days. For embodiments in which the writing instruments 10, 100 are made with an anaerobic biodegradable plastic, it is expected that the biodegradation period in a landfill will be greatly reduced as compared to a conventional plastic. Moreover, because the preferred embodiment pens are both non-toxic in their initial, writing-capable states and decompose into non-toxic materials, they will not add or contribute to the toxicity of the environment.

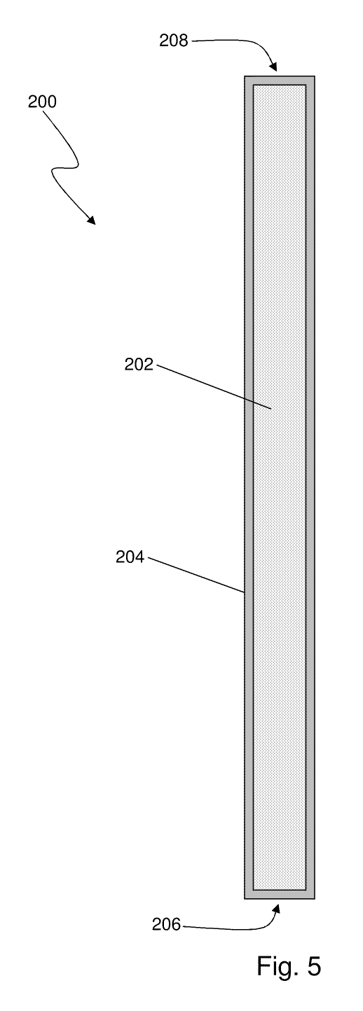

In some embodiments, the reservoir 42, 142 may further include a sheath that encloses that ink-holding material of the reservoir 42, 142. An embodiment reservoir 200 is shown in cross-section in FIG. 5. The reservoir 200 may be used, for example, as the reservoir 42, 142 in the above-described embodiment writing instruments 10, 100. The reservoir 200 includes an ink-holding material 202, which may be any suitable material that is preferably biodegradable and non-toxic, such as any of the materials discussed above with reference to the reservoirs 42, 142. The ink-holding material 202 is surrounded by, and thus contained within, a sheath 204. One or more of the ends 206, 208 of the sheath 204 may include an opening to provide access to the ink-holding material 202 for the nib sub-assembly. Alternatively, the sheath 204 may not enclose one or both of the ends 206, 208, so that the ink-holding material 202 may be exposed at one or both of the ends 206, 208. The sheath 204 may provide additional structural rigidity to the reservoir 200, and further may help to prevent drying out of the ink held within the material 202. The sheath 204 is preferably non-toxic and biodegradable, and may be in the form of a film, canister or the like. In preferred embodiments the sheath 204 is a film made from a material that has a low vapor transmission rate, such as less than 100 g/m²/24 h. Example materials for the sheath 204 include polypropylene with EcoPure as an additive, which may be particularly suitable when the ink-holding material 202 is made from wool. Other preferred materials include a film made from Bioplast.

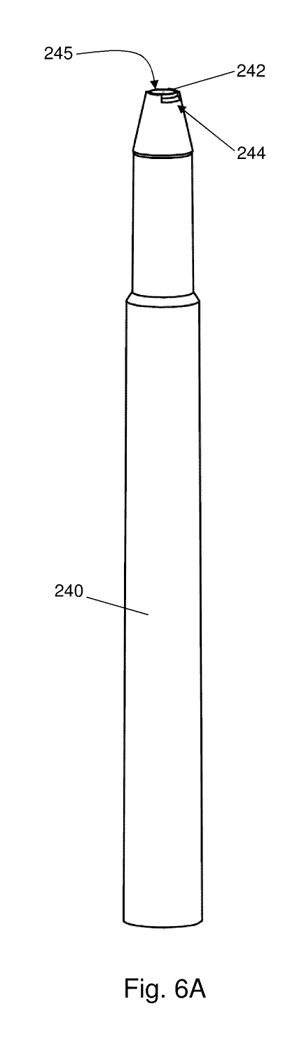

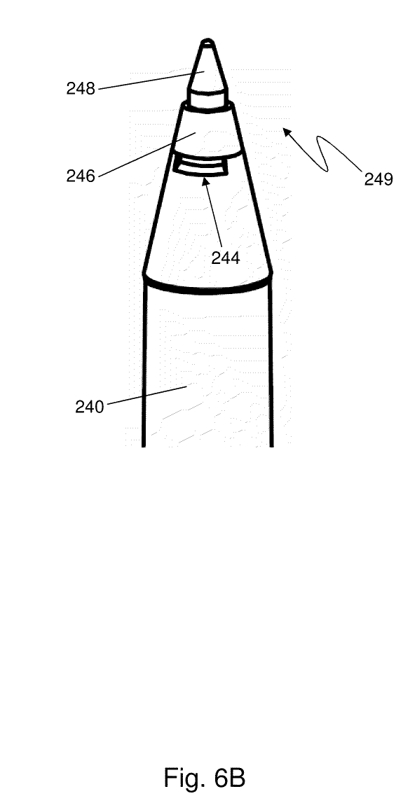

FIGS. 6A and 6B show views of another embodiment main housing 240, which may be a suitable substitute for any of the main housings 40, 140 discussed above. The main housing 240 is preferably made from a non-toxic, biodegradable material as discussed above, and so is compostable. The main housing 240 includes an opening 245 sized to accept a nib sub-assembly 249. More particularly, the opening 245 includes a rim 242. Around a portion of this rim 242 an indentation 244 is formed. The nib adapter 246 of the nib sub-assembly 249 sets within the opening 245 and abuts against the rim 242. Because of the indentation 244, a portion of the bottom section of the nib adapter 246 is exposed. The indentation 244 allows removal of the nib sub-assembly 249 by pinching at the indentation 244 with the fingernails and pulling. A user may thus dispose of the main body 240 and the components disposed therein separately from the nib-subassembly 249. This may be beneficial as in some embodiments the nib 248 is made from stainless steel, and thus is not compostable. The indentation 244 thus permits the user to separate compostable elements of the pen from non-compostable elements, and in particular facilitates the separation of the nib 248 from the main housing 240.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A writing instrument comprising:
a biodegradable main housing;
a biodegradable ink reservoir disposed within the main housing;
ink disposed within the ink reservoir; and
a nib coupled to the main housing and fluidly connected to the ink reservoir.

2. The writing instrument of claim 1 further comprising a biodegradable plug for plugging an end of the main housing.

3. The writing instrument of claim 1 further comprising a wick fluidly connected to the nib and the ink reservoir.

4. The writing instrument of claim 3 further comprising a nib adapter mechanically coupled to the wick and to the nib, the nib adapter adapted to mechanically engage with the main housing.

5. The writing instrument of claim 4 wherein the nib adapter is biodegradable.

6. The writing instrument of claim 4 wherein the nib is a rollerball nib.

7. The writing instrument of claim 3 wherein the nib is integrally formed with the wick.

8. The writing instrument of claim 7 wherein the nib is a felt tip nib.

9. The writing instrument of claim 3 wherein the wick is biodegradable.

10. The writing instrument of claim 1 wherein the ink is non-toxic.

11. The writing instrument of claim 10 wherein the ink is biodegradable.

12. The writing instrument of claim 1 wherein the main housing comprises at least one of a biodegradation-enhancing additive or a biodegradable polymer.

13. The writing instrument of claim 1 wherein the ink reservoir comprises an ink-holding material and a sheath surrounding at least a portion of the ink-holding material.

14. The writing instrument of claim 1 wherein the main housing comprises an indentation to facilitate removal of the nib from the main housing.

15. The writing instrument of claim 1 wherein the main housing is compostable.
